(19) United States
(12) Patent Application Publication
(10) Pub. No.: US 2014/0220267 A1
(43) Pub. Date: Aug. 7, 2014

(54) ELASTIC ALIGNMENT AND RETENTION SYSTEM AND METHOD

(71) Applicant: GM Global Technology Operations LLC, Detroit, MI (US)

(72) Inventors: Steven E. Morris, Fair Haven, MI (US); Edward D. Groninger, Macomb, MI (US); Raymond J. Chess, Oxford, MI (US)

(73) Assignee: GM Global Technology Operations LLC, Detroit, MI (US)

(21) Appl. No.: 13/954,198

(22) Filed: Jul. 30, 2013

Related U.S. Application Data
(60) Provisional application No. 61/703,252, filed on Sep. 19, 2012.

(51) Int. Cl. B32B 7/04; B32B 7/08

(52) U.S. Cl. CPC B32B 7/045; B32B 7/08
USPC 428/33; 29/450

(57) ABSTRACT

An elastic convex wall alignment and retention system includes a first component, second component, a plurality of elastic convex walls disposed on at least one of the first component and second component each having a convex wall surface, non-convex wall surface and a longitudinal axis and a pair of spaced-apart, retention features that oppose one another about the axis, each retention feature extending outwardly from the convex wall surface; and a plurality of apertures formed in at least one of the first component and second component, each aperture having an aperture wall, the plurality of apertures configured and arranged such that each elastic convex wall is receivable into a respective aperture, wherein each elastic convex wall is configured to elastically deform at an interface between the convex wall and the aperture wall upon insertion to establish an elastically averaged position of the first component to the second component.

### CROSS-REFERENCE TO RELATED APPLICATIONS

This patent application claims priority to U.S. Provisional Patent Application Ser. No. 61/703,252 filed Sep. 19, 2012, which is incorporated herein by reference in its entirety.

### FIELD OF THE INVENTION

The subject invention relates to location features and a system for aligning and retention of components having a relatively small size or contact area during a mating operation.

### BACKGROUND

Currently, components which are to be mated together in a manufacturing process are mutually located with respect to each other by 2-way and/or 4-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first component and second component, which contributes to the presence of undesirably large and varying gaps and an otherwise undesirable fit therebetween.

The problem of positional variation also exists in the mating and retention of parts that have a relatively small size or contact area over which the parts are mated. In mating such components, there is often not enough space to provide upstanding bosses and corresponding female alignment features, such as apertures in the form of holes or slots, in the mating component. In such situations, positional location and retention are often combined by attachment using adhesives, including double sided adhesive tape, where the components are visually and manually aligned to one another and pressed into adhesive contact. The assembly of such components often results in undesirable non-uniform gaps and spacings between the components, including the presence of undesirably large assembly-to-assembly variations.

In addition to such positional variations, the components need to be retained in the desired position once it has been established. Heat staking the adjacent components is one method that has been utilized. However, it is not always a desirable method, particularly when the adjacent components and/or the alignment features used are small. Heat staking is also undesirable when the space envelope available or the amount of material of the features is small such that the components do not readily lend themselves to heat staking or the use of other retention devices or methods.

Therefore, an improved alignment and retention system and method for components that have a relatively small size or contact area over which the parts are mated is very desirable.

### SUMMARY OF THE INVENTION

In one exemplary embodiment, an elastic convex wall alignment system for aligning components to one another is disclosed. The system includes a first component and a second component. The system also includes a plurality of elastic convex walls disposed on at least one of the first component and second component, the convex walls each having a convex wall surface and a non-convex wall surface and a longitudinal axis. The system further includes a pair of spaced-apart, retention features that oppose one another about the longitudinal axis, each retention feature extending outwardly from the convex wall surface. The system further includes a plurality of apertures formed in at least one of the first component and second component, each aperture having an aperture wall, the plurality of apertures configured and arranged such that each elastic convex wall is receivable into a respective aperture, wherein each elastic convex wall is configured to elastically deform at an interface between the convex wall and the aperture wall when the elastic convex wall is inserted into the respective aperture to establish an elastically averaged position of the first component to the second component, wherein each elastic convex wall has a width larger than a cross-section of its respective aperture.

In another exemplary embodiment, a method for aligning components of a motor vehicle during a mating operation is disclosed. The method includes providing a first vehicle component, the first vehicle component comprising a plurality of elastic convex walls, the convex walls each having a convex wall surface, a non-convex wall surface, a longitudinal axis and a pair of spaced-apart, retention features that oppose one another about the longitudinal axis, each retention feature extending outwardly from the convex wall surface. The method also includes providing a second vehicle component having a plurality of apertures formed therein, each aperture having an aperture wall, the plurality of apertures configured and disposed relative to the plurality of elastic convex walls such that each elastic convex wall is receivable into a respective aperture. The method further includes mating the first vehicle component to the second vehicle component, wherein during mating the first vehicle component is aligned to the second vehicle component by each elastic convex wall being received into a corresponding aperture. The method also includes elastically deforming an interface between each elastic convex wall and its respective aperture in the second vehicle component while elastically deforming the retention features so the retention features are configured to pass through the corresponding aperture. The method further includes performing the elastic deformation over the plurality of elastic convex walls such that upon mating, the first vehicle component establishes an elastically averaged position relative to the second vehicle component; and retaining the first vehicle component against the second vehicle component by engaging the retention features against the aperture walls.

### BRIEF DESCRIPTION OF THE DRAWINGS

Other features, advantages and details appear, by way of example only, in the following detailed description of embodiments, the detailed description referring to the drawings in which:

FIG. 1 is a schematic top plan view of an embodiment of an alignment and retention system and assembly as disclosed herein;

FIG. 2 is a cross-sectional view of FIG. 1 taken along Section 2-2 illustrating an embodiment of an elastic convex wall as disclosed herein;

FIG. 3 is a cross-sectional view of another embodiment of an elastic convex wall as disclosed herein;

FIGS. 4A-4G are schematic top views of various embodiments of elastic convex walls as disclosed herein;

FIG. 5 is a flowchart of a method of aligning an assembly of components as disclosed herein;

FIG. 6 is a perspective view of a convex wall having spaced-apart, axially-extending wings as described herein;

FIG. 7 is a top view of an embodiment of an elastic convex wall and wings prior to insertion into an aperture;

FIG. 8 is a top view of the embodiment of FIG. 7 during insertion into an aperture and deformation of the wings;

FIG. 9 is a top view of the embodiment of FIG. 7 after insertion into an aperture and deployment of the wings, wherein the wings have retained elastic deformation to bias the wings and the elastic convex tube against the periphery of the aperture;

FIG. 10 is a front view of the convex wall and wings of FIG. 9; and

FIG. 11 is a top perspective view of an embodiment of an alignment and retention system and assembly as disclosed herein.

### DESCRIPTION OF THE EMBODIMENTS

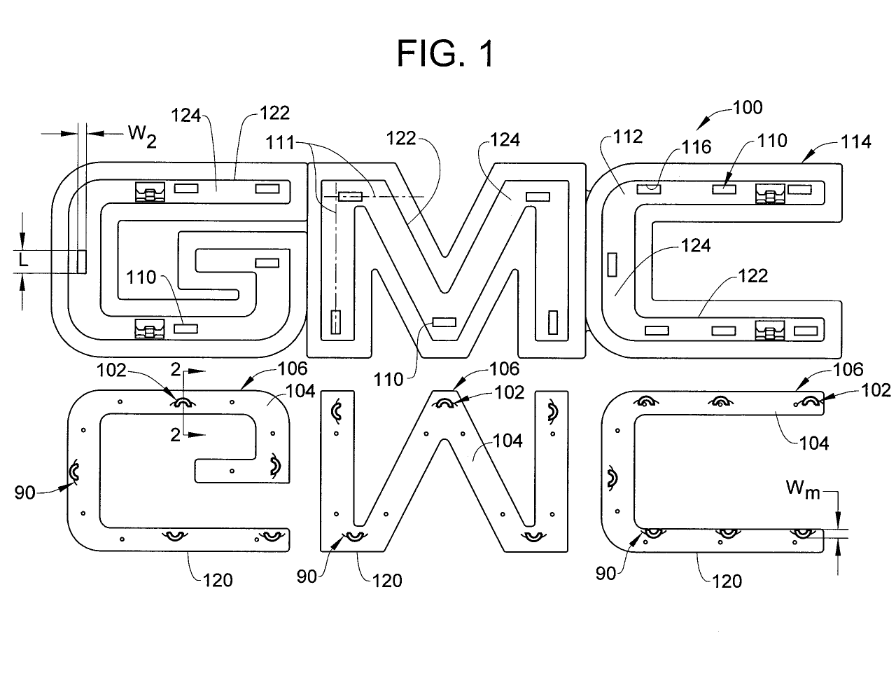

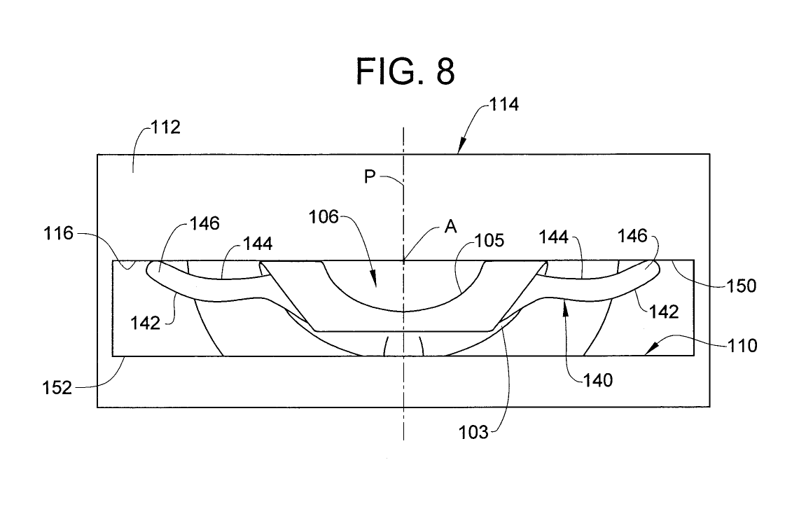

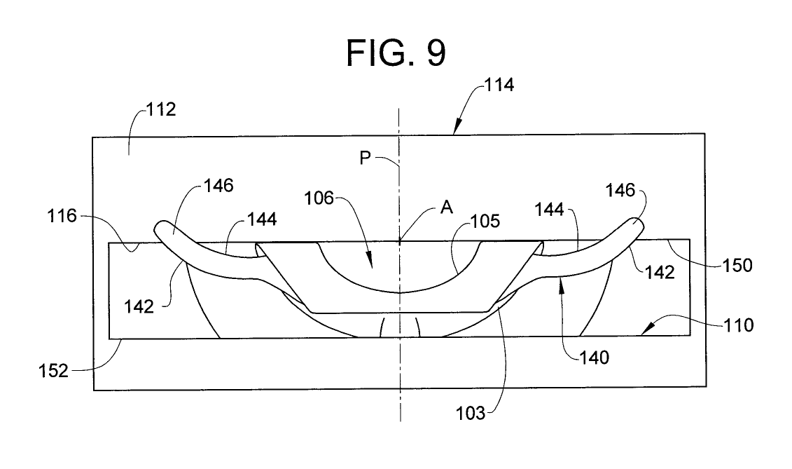

The following description is merely exemplary in nature and is not intended to limit the present disclosure, its application or uses. Referring to the Figures, including FIGS. 1-11, the subject invention comprises an elastic convex wall alignment and retention system 100 and method for the desired mating of two components 106, 114, such as motor vehicle components, for example, wherein when mating of the components is completed there is a lack of float (or play) as between the male and female alignment features so as to provide a desired alignment and retention with stiffened positional constraint, yet the aligned mating and retention proceeds substantially smoothly and effortlessly each time.

The embodiments shown herein comprise vehicle emblems as may be used, for example, to identify a vehicle brand or make, or a vehicle model, or a model feature or characteristic (e.g., hybrid, AWD and the like). However the claimed subject invention should not be so limited, the alignment and retention system 100 may be used with any suitable components to provide elastic averaging for desired location and alignment and retention of all manner of mating components and component applications, including many industrial, consumer product (e.g., consumer electronics, various appliances and the like), transportation, energy and aerospace applications, and particularly including many other types of vehicular components and applications, such as various other interior, exterior and under hood vehicular components and applications, for example. The elastic convex wall alignment and retention system 100 is particularly useful for the desired mating alignment and retention of two components 106, 114 where one or both of the components have fine spacing or narrow features, such as rails, frames, channels, ribs or arms that define letters, logos, symbols, or trim pieces, particularly those where the size of the components will not accommodate the implementation of other alignment and retention systems that include larger alignment features, such as full elastic averaging tubes or tabs, and/or retention features, such as heat-staked joints and threaded fasteners, for example. It should be understood that throughout the drawings, corresponding reference numerals indicate like or corresponding parts and features. The alignment system 100 may be employed with any suitable number of components, and is not limited to application with only two components. While the embodiments herein are described using two components, more than two components can be aligned using the alignment system 100 described herein, including a third, fourth, etc. component, in any number.

As used herein, the terms “elastic” or “elastically deformable” and the like refer to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation, for example.

The elastic convex wall alignment and retention system 100 according to the subject invention operates on the principle of elastic averaging. A plurality of geometrically separated elastic convex wall (male) alignment features 102 are disposed on a first component 106, while a plurality of one-to-one corresponding aperture (female) alignment features 110 are provided on a second component 114, wherein the elastic convex wall alignment features 102 have a width that exceeds a cross-section of the aperture alignment features 110. However, the first and second components 106, 114 may each have some of the elastic convex wall alignment features 102 and some of the aperture alignment features 110 so long as they one-to-one correspond and allow mutual engagement with one another. During the mating of the first component 106 to the second component 114, each elastic convex wall alignment feature 102 respectively engages its corresponding aperture alignment feature 110. As the elastic convex wall alignment features 102 are received into the aperture alignment features 110, manufacturing variances, in terms of position and size of the elastic convex wall and aperture alignment features, are accommodated by elastic deformation to establish an elastically averaged position at the interface between the elastic convex wall and aperture alignment features. This elastic averaging across the plurality of elastic convex wall and aperture alignment features 102, 110 provides a desired alignment as between the first and second components 106, 114 when they are mated relative to each other, and yet the mating proceeds smoothly and easily. The elastic convex wall (male) alignment features 102 also include at least one, and desirably a plurality of retention features 90.

Elastic averaging provides elastic deformation of the interface(s) between mated components, wherein the average deformation provides a desired alignment, the manufacturing positional variance being reduced or minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675 filed on Jul. 21, 2011 and Ser. No. 13/567,580 filed on Aug. 6, 2012, the disclosures of which are incorporated by reference herein in their entirety. The embodiments disclosed above provide the ability to convert an existing component that is not compatible with the above-described elastic averaging principles to an assembly that does facilitate elastic averaging and the benefits associated therewith. Thus, the needed clearance for the male and female alignment features of the prior art is obviated by the subject invention.

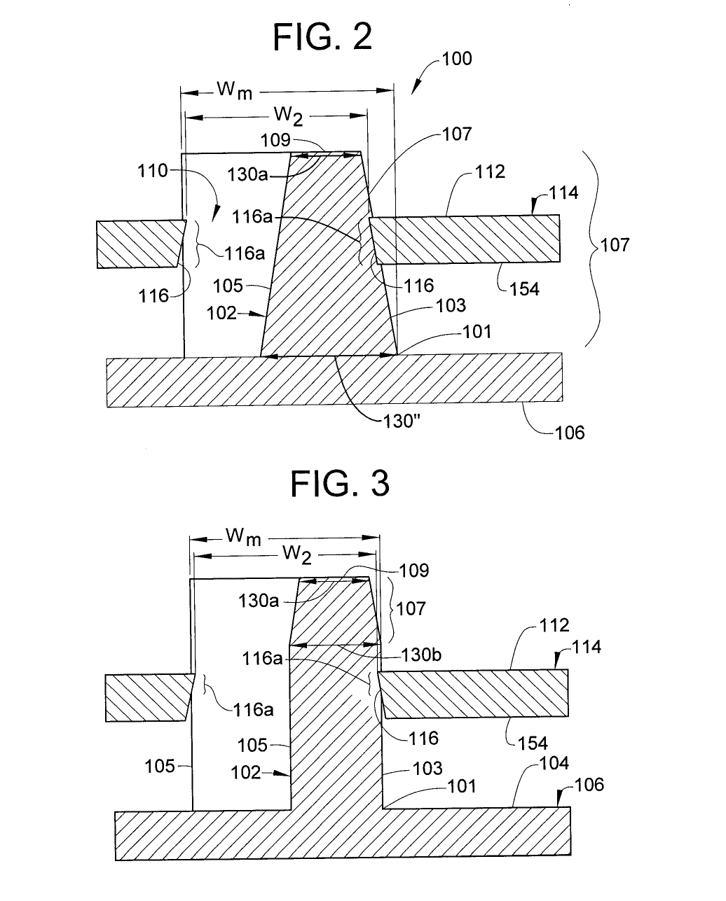

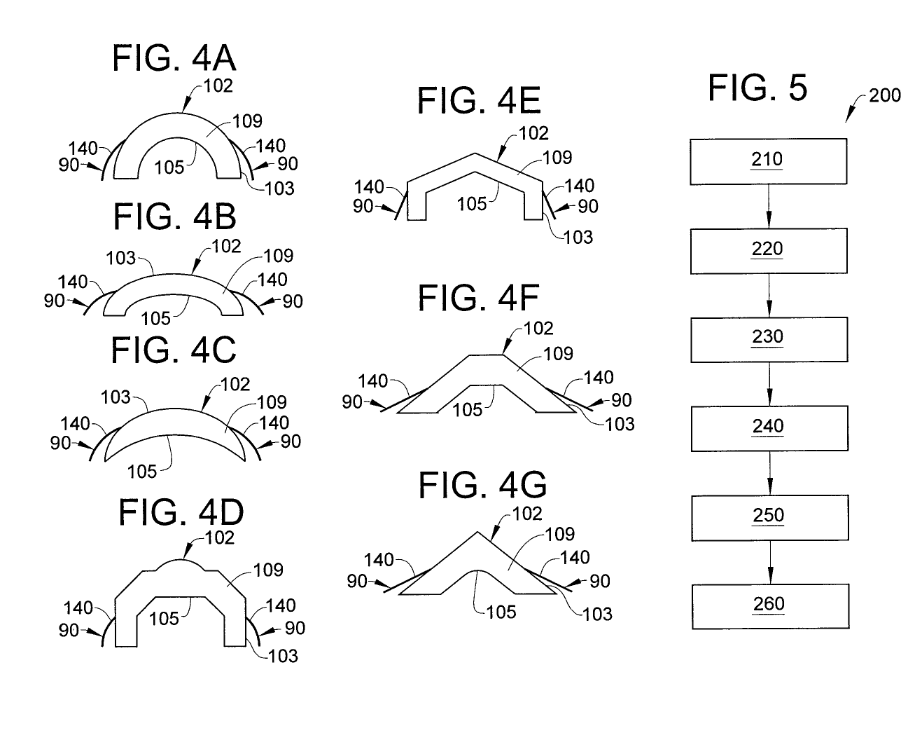

According to an embodiment, the elastic convex wall alignment features 102 are elastically deformable by elastic compression of the convex wall surface 103 (FIG. 2) of the elastic convex wall 102, which deformation is desirably resiliently reversible. In an exemplary embodiment, the elastic convex wall alignment features 102 are connected with a first component 106 in upstanding, perpendicular relation to a predetermined first surface 104 of the first component 106. In one embodiment the convex wall alignment features are integrally formed in the first component 106. Further, in yet another embodiment the respective aperture alignment members are elastically deformable by elastic expansion of the aperture wall of the aperture alignment features 110, which deformation is resiliently reversible. In an exemplary embodiment, the aperture alignment features 110 are disposed in a second component 114, typically as a slot or a hole in predetermined surfaces of the second component 114, wherein the width of the elastic convex wall alignment features 102 exceeds the cross-sectional width of the aperture alignment features 110 (i.e., an interference condition exists), whereby elastic deformation occurs as each elastic convex wall alignment feature 102 is received into its respective aperture alignment feature 110. The process of mating with desired alignment is both smoothly and easily performed. This is enhanced by a tapering (smaller diameter with increasing height) of the elastic convex wall alignment features 102, such as a chamfer or taper, so as to facilitate their initial entry into the aperture alignment features, and by beveling of the aperture wall 116 of the aperture alignment features so as to locally pronounce the elastic deformation at the interface of the aperture wall with the elastic convex wall alignment feature 102. Once inserted and aligned, the retention features 90 (FIGS. 4A-4G) deformably engage the interface (e.g. surface) of the mating part, such as the surface proximate the periphery of the aperture alignment features, to retain the elastic convex wall alignment features within the respective aperture alignment features.

In operation, as the first and second components are mated together, the initial contact therebetween is at the plurality of geometrically spaced apart elastic convex wall alignment members passing into their one-to-one corresponding aperture alignment features. Due to of the larger size of the width of the elastic convex wall alignment features relative to the cross-section of the aperture alignment features, an elastic deformation occurs at the interface therebetween, and this deformation is averaged over the geometrical distribution of the plurality of elastic convex wall alignment features. The alignment achieves a desired precision when all of the first and second components have fully mated due to the tapering of the elastic convex wall alignment features provide a width to the cross-section of the aperture alignment features when these components have arrived at final mating.

Once aligned, an affixment modality is implemented that utilizes the elastic averaging feature (e.g., convex feature) to retain or aid in retaining the mating part. This can be accomplished by adding a retention feature, such as radially-outwardly extending wings, for example, on the elastic averaging features that are configured to deploy so that they extend radially-outwardly at and act against the interface (e.g. surface) of the mating part, such as the surface 112 proximate the aperture alignment features 110, to retain the elastic convex wall alignment features 102 within the respective aperture alignment features 110. These retention features 90 allow the elastic convex wall alignment features 102 to act against the surface 112 of the mating part once the elastic convex wall alignment features 102 and retention features 90 are inserted into the corresponding aperture alignment features 114 in the mating component. Thus, the retention features 90 are self-retaining features as they act to retain the first component 106 without the need for a separate operation (e.g. heat staking) or device (e.g. threaded fastener) to affix the first component 106 to the second component 114. For example, in the case of a semi-circular alignment feature shown in FIG. 4A, as the feature is pushed through a slot on the mating part, axially and radially extending wings 140 push through the aperture alignment feature 110, such as a slot, deforming like a clip fastener and then spring back to act against the surface of the mating component and retain the mating part.

In addition to the alignment obtained using the alignment features 102, 110 and the reduction of positional variation of the components, the alignment and retention system 100; the retention features 90 provide the ability to also retain the interfacing components. This advantageously reduces or eliminates the need to employ heat staking, metal clips, dog houses, rivets, threaded fasteners and other secondary retaining features, for example. This also potentially reduces assembly labor, provides a reduced weight, and also improves the interface between the parts and the visible joint between the two components to provide an enhanced Class A finish with predetermined uniform gaps and spacings between the components having been established.

Referring now to the Figures, FIGS. 1-10 depict various examples of the structure and function of the elastic convex wall alignment system 100 disclosed herein. The elastic convex wall alignment system 100 operates on the principle of elastic averaging as described herein. A plurality of mutually separated elastic convex wall alignment features (serving as male alignment features) 102 (hereinafter referred to simply as “elastic convex walls”) are disposed on a first surface 104 of a first component 106, or a plurality of first components 106 (FIG. 1). As best shown in FIGS. 1-3, the elastic convex walls 102 are upstanding in a normal relation to the first surface 104, wherein a plurality of mutually separated elastic convex walls 102 are spaced apart from one another on the surface of the first component 106. The elastic convex walls 102 may be spaced apart in any suitable pattern, and will desirably be arranged in a pattern or geometrical distribution that provides a predetermined alignment of the first component 106 and the second component 114, such as a predetermined gap or spacing (e.g. a uniform gap or spacing) of the periphery 120 on first component 106 (or components) nested within a periphery 122 of a mating recess 124 of the second component 114. Each of the elastic convex walls 102 is convex in shape, having a convex surface 103. The convex wall surface 103 of the elastic convex wall 102 may have any suitable convex shape, including all manner of convex curved surface shapes (FIGS. 4A-4C) and convex polygonal surface shapes (FIGS. 4E-4G) or combinations thereof (FIG. 4D). Suitable convex curved wall surface 103 shapes include any convex arcuate wall surface 103 shape, such as, for example, semitubular or semicylindrical shapes (FIGS. 1-3 and 4A), elliptical shapes (FIG. 4B), crescent or halfmoon shapes (FIG. 4C) and other convex arcuate wall surfaces, including those that are defined by a circular arc extending less than 180 degrees (FIG. 4D). Suitable polygonal convex wall surface 103 shapes include any regular or irregular polygonal surface shapes having various acute angles therebetween, including various four-sided shapes (FIG. 4E), three-sided shapes (FIG. 4F) and two-sided shapes (FIG. 4G). The convex wall surface 103 of the elastic convex wall 102 also has an opposed surface 105. The opposed surface 105 may have any suitable shape, including a curved concave wall surface (FIGS. 4A-4C) and a polygonal concave wall surface FIGS. 4E-4G. The convex wall surfaces 103 and opposing surfaces 105 may be combined in any manner, including any of the convex wall surfaces 103 illustrated with any of the opposing wall surfaces 105. These shapes are only exemplary illustrations of many curved and polygonal convex wall surfaces 103 and opposing wall surfaces 105 that may be employed. The elastic convex wall has a width (Wₘ) as shown in FIGS. 1-3. The elastic convex wall 102 also may have a bevel 107 proximate a distal 109 end of the wall. The bevel 107 may extend along a portion of the wall (FIG. 3) or along the entire wall (FIG. 2). The elastic convex wall 102 is elastic, being preferably stiffly elastic, wherein the shape is resiliently reversible in response to an elastic compressive force being applied thereto sufficient to elastically deform the elastic convex walls 102.

A plurality of aperture alignment features (serving as female alignment features) 110 (hereinafter referred to simply as “apertures”) are disposed in a second surface 112 of a second component 114, being located in one-to-one correspondence with the plurality of elastic convex walls 102; that is, for each elastic convex wall is a respective aperture into which it is receivable. Thus, the plurality of apertures 110 are geometrically distributed in a coordinated relationship to a geometrical distribution of the plurality of elastic convex walls such that each elastic convex wall is receivable into its respective aperture. While the apertures 110 are shown as elongated slots, the aperture shape may be otherwise, such as, for example, an elongated hole, a generally round hole, etc. In one embodiment, an aperture wall 116 which defines the opening demarcation of the aperture alignment features 102 is beveled. A desired material for the second component 114 in which the apertures 110 are disposed is one having elastic properties so as to elastically deform without fracture, as described herein.

The apertures 110 may have any suitable shape, including an elongated shape having a length (L) greater than the width (W₂), such as a rectangle, rounded rectangle, or a rectangular shape having ends defined by outwardly extending, opposed curved (e.g. circular) arcs. In one embodiment, the elongated apertures may have a substantially uniform aperture width except in the end regions, which may be rounded or curved as described herein. The apertures 110 of a given component may have the same size, or different sizes, so long as the size of the aperture corresponds to the size of the elastic convex wall 102 to which it is aligned in the manner described herein. The apertures of the second component 114 have a second aperture width (W₂).

The elongated apertures 110 of the second component 114 have second elongation axes 111 along their length (i.e. the elongated dimension). For respective apertures 110, the apertures may be arranged so that the respective axes are parallel to one another or not parallel to one another. In one embodiment, a predetermined portion of the second elongation axes 111 are parallel. In another embodiment, a predetermined portion of the second elongation axes 111 are not parallel to the other second elongation axes 111, and in certain embodiments may be orthogonal to these axes.

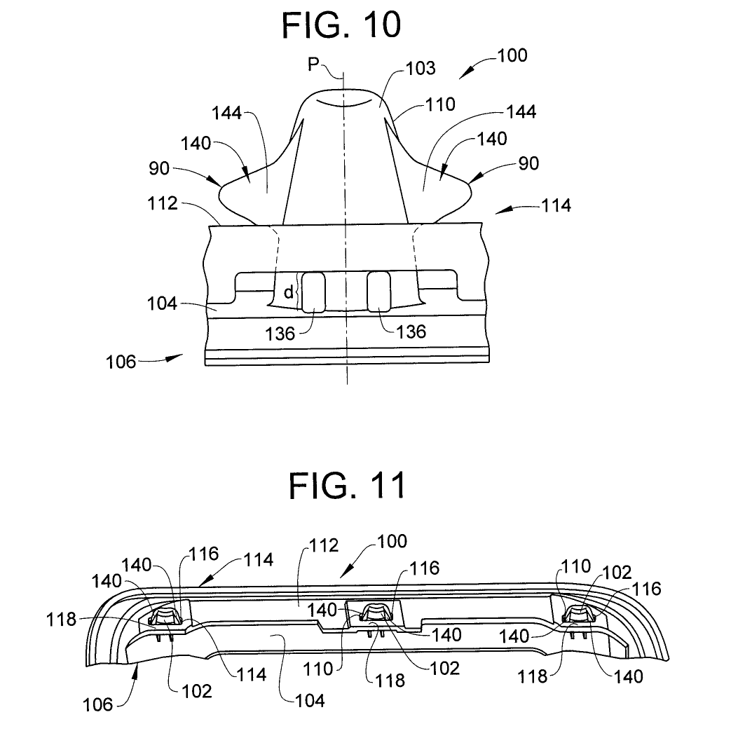

As depicted schematically in FIGS. 2 and 3, the maximum width Wₘ of the elastic convex walls 102 exceeds a width W₂ of the apertures 110, whereby elastic deformation proceeds as each elastic convex wall 102 is received into its respective aperture 110. As in FIGS. 2 and 3, the elastic deformation of the convex wall surface 103 is locally pronounced due to the beveling of the aperture wall 116, wherein there is provided a relatively small contact surface 116a area as between the aperture wall 116 and the portions of the convex tube wall surface 103 and opposed tube wall surface 105 that it is in contact with. Since the compressive force between the aperture wall 116 and the tube wall surfaces 103, 105 is limited to the smaller surface area of the aperture wall contact surface 116a, a higher compressive pressure to deform the elastic convex walls 102 and/or the aperture walls 116 is provided. The location of the first component 106 relative to the second component 114, including their spacing (d) may be established using one or more standoffs 136 (FIG. 10) that are affixed to either the first component 106, second component 114, or a combination thereof. Standoffs 136 may be located proximate the elastic convex walls 102 or apertures 110.

Any suitable elastically deformable material may be used for the first component 106 or second component 114, for example, particularly those materials that are elastically deformable when formed into the features described herein. This includes various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features and components described herein. The elastic convex walls 102 may be formed in any suitable manner. They may be integrally formed or manufactured with the first component 106 or they may formed together separately and attached to the first component, or they may both be formed entirely separately and attached to the first component. When formed separately, they may be formed from different materials than those of the first component 106 to provide a predetermined elastic response characteristic, for example. The material, or materials, may be selected to provide a predetermined elastic response characteristic of any or all of the first component 106 or second component 114. The predetermined elastic response characteristic may include, for example, a predetermined elastic modulus.

The process of mating the first component 106 to the second component 114 is facilitated by a tapering (smaller diameter with increasing height) the elastic convex walls 102 as shown comparatively at FIG. 3. In the exemplary embodiment, the tapering occurs between the distal and proximal diameters 130a and 130b of the distal end 109 and proximal ends 101 of the elastic convex wall 102. In this regard, the tapering of the elastic convex walls presents a larger diameter 130b, which may be the largest diameter, at the cross-section of the apertures 110 when the first and second components have arrived at final mating; further, the tapering may present a smallest diameter 130a of the elastic convex wall 102 at the distal end 109 so as to ease initial entry of the elastic convex walls into the apertures.

During the mating of the first component 106 to the second component 114, each elastic convex wall 102 respectively engages its corresponding aperture 110 wherein as the elastic convex walls pass into the apertures, manufacturing variances in terms of position and size thereof, is accommodated by elastic deformation on average of the plurality of elastic convex walls 102 and apertures 110. This elastic averaging across the plurality of elastic convex walls and apertures 102, 110 provides a desired alignment as between the first and second components 106, 114, and any additional components, when they are finally mated relative to each other.

Further, as discussed above, it is possible for the aperture alignment members 110 to be also elastically deformable by elastic expansion of the aperture wall 116, which deformation may also be reversible. An example is shown in FIG. 11, where at least one of the aperture walls 116 comprises a wall of an elastically deformable fixed-fixed beam 118.

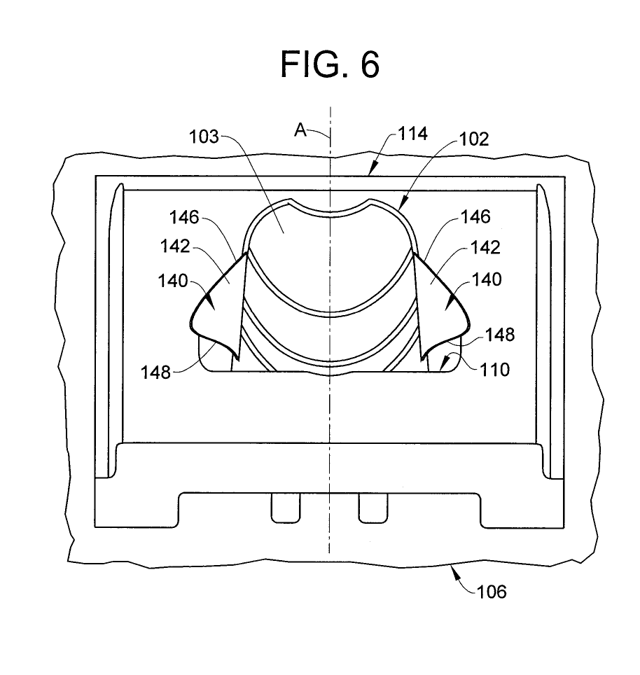

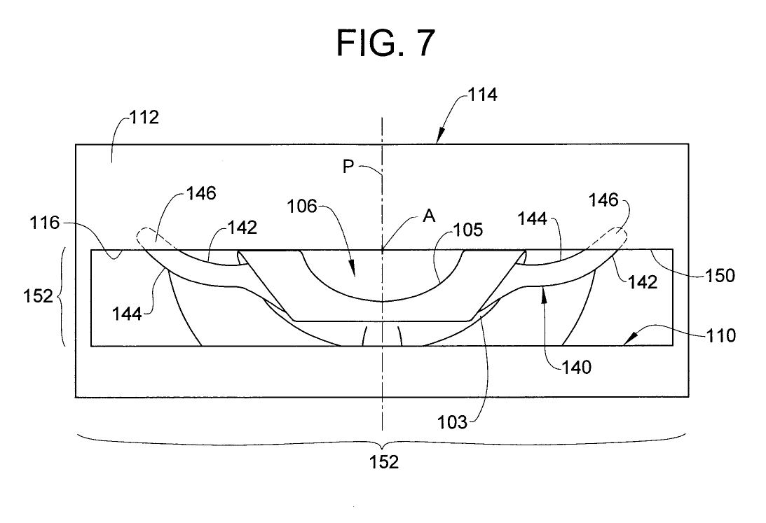

Referring to FIGS. 6-10, each elastic convex wall 102 includes a pair of elastically deformable, spaced-apart, axially-extending wings 140 that extend along and oppose one another about the longitudinal axis (A), each wing also extending radially outwardly from the elastic convex wall surface 103. In one embodiment, the wings may be described as axially and radially extending wings 140, since they extend both axially along the longitudinal axis (A) and radially away from it and the convex wall surface 103. In one embodiment, the wings 140 comprise mirror images disposed about a longitudinally extending bisecting plane (P). The axially-extending wings 140 may have any suitable shape including various flat planar and curved shapes, and may extend at any suitable angular orientation from the intersection with the convex wall surface 103, including various acute, orthogonal or obtuse angles. In one embodiment, the elastically deformable, spaced-apart, axially-extending wings 140 comprise a curved shape with each wing having a convex wing surface 142 and a concave wing surface 144 as shown in FIGS. 7-9. The concave wing surfaces 144 are concave with reference to the non-convex wall surface 105 and the convex wing surfaces 142 are convex with reference to the convex wall surface 103. Each axially-extending wing 140 also has a leading edge 146 and a trailing edge 148 and the plurality of wings 140 are axially and radially positioned on the elastic convex wall 102 and configured so that they are elastically deformable during insertion of the wall into the aperture 110 so that the wings 140 are deflected into and are able to pass through the aperture 110 as the wall 102 is inserted and then elastically spring back out of the apertures 110 as the leading edges 146 exit the apertures 110. The leading edges 146 are axially and radially positioned and configured to deformably engage the aperture wall 116 first upon insertion into the aperture 110. The trailing edges 148 are axially and radially positioned and configured to deformably engage the aperture wall 116 and the second (e.g. upper) surface 112 of the second component 114 proximate the periphery 152 of the aperture 110 when the elastic convex wall 102 is fully seated in the corresponding aperture 110 and the wings have at least partially elastically sprung back toward their initial undeformed position. In one embodiment, the axially-extending wings 140 do not return to their initial undeformed position, but rather only partially spring back toward this position and thus retain a predetermined amount of elastic deformation therein and a predetermined retention force because the trailing edges 148 of the wings continue to act against the aperture wall 116 and the second (e.g. upper) surface 112 of the second component 114 proximate the periphery 152 of the aperture 110 and thereby provide a predetermined retention force to bias the axially-extending wings 140 and the elastic convex walls 102 of the first component 106 against them. In this embodiment, in the full inserted position of the elastic convex wall there remains a deformed portion of the axially-extending wings 140 that is biased against and in pressed engagement with the second component 114. As such, the axially-extending wings 140 provide a retention feature that retains the alignment of the first component 106 and the second component 114 as described herein. In one embodiment, the retention feature is selectively removable or releasable because the retention force applied against the first component 106 by the second component 114 by the axially-extending wings 140 may be overcome by applying a force against the lower surface 154 (FIG. 1) of the first component 106 sufficient to overcome the predetermined retention force.

The wings 140 may have any suitable thickness, size and shape. In one embodiment the wings 140 have a thickness that is substantially thinner than the thickness of the elastic convex wall 102. In one embodiment, the wings 140 are integral and are formed together with the elastic convex wall 102. In one embodiment, the elastic deformation comprises resiliently reversible elastic deformation of each convex wall 102 and the wings 140 attached thereto. In another embodiment, the resiliently reversible elastic deformation of each elastic convex wall 103 comprises deformation of the convex surface 103, the non-convex surface 105 and the wings 140.

In an exemplary embodiment, a method 200 (FIG. 5) for aligning components of a motor vehicle during a mating operation is disclosed. The method 200 includes providing 210 a first vehicle component 106, the first vehicle component comprising a plurality of upstanding elastic convex walls 102, each having a plurality of retention features 90 comprising elastically deformable, axially and radially extending wings 140, connected to the first component 106, the convex walls each having a convex wall surface 103 and a non-convex wall surface 105. The method 220 also includes providing a second vehicle component 114 having a plurality of apertures 110 formed therein, each aperture having an aperture wall 116, the plurality of apertures of the second component geometrically distributed in a coordinated relationship to a geometrical distribution of the plurality of elastic convex walls such that each elastic convex wall 102, and its associated retention features 90, is receivable into a respective aperture 110. The method further includes 230 mating the first vehicle component 106 to the second vehicle component 114, wherein during mating the first vehicle component is aligned to the second vehicle component by each said elastic convex wall 102 and its associated retention features 90 being received into its respective aperture 116. Still further, the method 200 includes elastically deforming 240 an interface between each elastic convex wall 102 and its respective aperture 110 in the second vehicle component 114. Yet further, the method 200 includes performing 250 an elastic averaging of the elastic deformation over the plurality of elastic convex walls such that upon mating, a desired location of the first vehicle component to the second vehicle is realized and retaining 260 the first component 106 against the second component 114 by action of the retention features 90, particularly the wings 140, against the apertures 110 of the second component 114 as described herein.

Several notable aspects and advantages of the subject invention may be understood from the foregoing description. The subject invention: 1) reduces or eliminates the manufacturing variation associated with the clearances needed for the 2-way and 4-way locating schemes of the prior art; 2) reduces the manufacturing variation by elastically averaging the positional variation; 3) reduces or eliminates the float of components as is present in the prior art; 4) provides an over constrained condition that reduces the positional variation by averaging out each locating features variation, and additionally stiffens the joint reducing the number of needed fasteners; 5) provides more desired location of components; and, 6) provides a stiffened assembly of the mated first and second components with reduction or elimination of buzz, squeak and rattle (BSR) through elastic deformation with respect to each other, and thereby improves the noise, vibration and harshness (NVH) performance of the assembly of the components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic convex wall alignment system for aligning components to one another, comprising:
a first component;
a second component;
a plurality of elastic convex walls disposed on at least one of the first component and second component, the convex walls each having a convex wall surface and a non-convex wall surface and a longitudinal axis;
a pair of spaced-apart, retention features that oppose one another about the longitudinal axis, each retention feature extending outwardly from the convex wall surface; and
a plurality of apertures formed in at least one of the first component and second component, each aperture having an aperture wall, the plurality of apertures configured and arranged such that each elastic convex wall is receivable into a respective aperture, wherein each elastic convex wall is configured to elastically deform at an interface between the convex wall and the aperture wall when the elastic convex wall is inserted into the respective aperture to establish an elastically averaged position of the first component to the second component, wherein each elastic convex wall has a width larger than a cross-section of its respective aperture.

2. The elastic convex wall alignment system of claim 1, wherein the elastic convex walls comprise elastic arcuate walls.

3. The elastic convex wall alignment system of claim 2, wherein the elastic arcuate walls each have a convex wall surface and a non-convex wall surface.

4. The elastic convex wall alignment system of claim 1, wherein the retention features comprise axially-extending wings.

5. The elastic convex wall alignment system of claim 4, wherein the wings comprises mirror images disposed about a longitudinally extending bisecting plane.

6. The elastic convex wall alignment system of claim 4, wherein each wing has a convex wing surface and a concave wing surface.

7. The elastic convex wall alignment system of claim 4, wherein each wing has a leading edge and a trailing edge, the leading edge configured to engage the aperture wall first upon insertion into the aperture, the trailing edge configured to engage the aperture wall when the convex wall is fully seated in the corresponding aperture and provide an retention force to bias the first component against the second component.

8. The elastic convex wall alignment system of claim 4, wherein the wings are integral with the convex wall.

9. The elastic convex wall alignment system of claim 1, wherein each elastic convex wall is configured to elastically deform the convex wall and the retention features.

10. The elastic convex wall alignment system of claim 4, wherein each elastic convex wall is configured to elastically deform the convex wall and the wings.

11. The elastic convex wall alignment system of claim 1, wherein each aperture wall is configured to elastically deform at an interface between the convex wall and the aperture wall when the elastic convex wall is inserted into the respective aperture.

12. The elastic convex wall alignment system of claim 1, wherein the elastically deformed convex walls provide a stiffened assembly of the first component and second component when these components are mutually mated to each other.

13. The elastic convex wall alignment system of claim 1, wherein each elastic convex wall is tapered having a smallest wall thickness on an end away from the first component.

14. The elastic convex wall alignment system of claim 1, wherein the apertures comprise elongated apertures.

15. The elastic convex wall alignment system of claim 14, wherein the elongated apertures comprise rectangular apertures.

16. The elastic tube alignment system of claim 14, wherein each elongated aperture has a beveled aperture wall at an entrance opening of the aperture.

17. The elastic tube alignment system of claim 1, wherein the first component comprises a plurality of first components.

18. A method for aligning components of a motor vehicle during a mating operation, the method comprising:
providing a first vehicle component, the first vehicle component comprising a plurality of elastic convex walls, the convex walls each having a convex wall surface, a non-convex wall surface, a longitudinal axis and a pair of spaced-apart, retention features that oppose one another about the longitudinal axis, each retention feature extending outwardly from the convex wall surface;
providing a second vehicle component having a plurality of apertures formed therein, each aperture having an aperture wall, the plurality of apertures configured and disposed relative to the plurality of elastic convex walls such that each elastic convex wall is receivable into a respective aperture;
mating the first vehicle component to the second vehicle component, wherein during mating the first vehicle component is aligned to the second vehicle component by each elastic convex wall being received into a corresponding aperture;
elastically deforming an interface between each elastic convex wall and its respective aperture in the second vehicle component while elastically deforming the retention features so the retention features are configured to pass through the corresponding aperture;
performing the elastic deformation over the plurality of elastic convex walls such that upon mating, the first vehicle component establishes an elastically averaged position relative to the second vehicle component; and
retaining the first vehicle component against the second vehicle component by engaging the retention features against the aperture walls.

19. The method of claim 18, wherein elastically deforming comprises resiliently reversible elastic deformation of each elastic convex wall.

20. The method of claim 19, wherein during providing, a manufacturing variance of size and position of the elastic convex walls and the apertures occurs, wherein the manufacturing variance has an average length of X, and wherein said step of elastic averaging provides a reduced manufacturing variance of length Xₘᵢₙ, where Xₘᵢₙ=X/√N, wherein N is the number of the elastic convex walls.
